(19) United States
(12) Patent Application Publication
(10) Pub. No.: US 2006/0022140 A1
(43) Pub. Date: Feb. 2, 2006

(54) Methods and apparatus for detection of contraband using terahertz radiation

(75) Inventors: James Connelly, St. Petersburg, FL (US); Jeffrey H. Stillson, Merrimack, NH (US)

Correspondence Address: WOLF GREENFIELD & SACKS, PC;FEDERAL RESERVE PLAZA, 600 ATLANTIC AVENUE, BOSTON, MA, 02210-2211, US

(73) Assignee: L-3 Communications Security and Detection Systems, Inc., Woburn, MA (US)

(21) Appl. No.: 11/140,558

(22) Filed: May 27, 2005

Related U.S. Application Data
(60) Provisional application No. 60/575,107, filed on May 27, 2004.

(51) Int. Cl. G01J 5/00

(52) U.S. Cl. 250/338.1; 250/341.1

(57) ABSTRACT

An inspection system and methods for inspecting items using terahertz radiation that may be used to detect contraband (e.g., explosives, weapons and drugs) within items under inspection. Terahertz radiation may be transmitted through and/or reflected from an item. The density and/or a physical property of one or more regions within an item may be determined. Terahertz radiation may be used to inspect surface regions of an item and/or other regions of an item. Terahertz radiation may used in combination with and/or in addition to another inspection modality.

### RELATED APPLICATIONS

This application claims benefit under 35 U.S.C. § 119(e) to U.S. Provisional Application Ser. No. 60/575,107, entitled “Method and Apparatus for Detection of Contraband Using Terahertz Time Domain Spectroscopy,” filed on May 27, 2004, which is hereby incorporated by reference in its entirety.

### BACKGROUND OF INVENTION

1. Field of Invention

The invention relates to contraband detection systems that use terahertz radiation.

2. Discussion of Related Art

Contraband detection systems are used to inspect items, such as luggage and packages, to detect the presence of contraband (e.g., weapons, explosives and drugs). Contraband detection systems may be used to inspect items at various locations, such as airports, points of entry and secure buildings. Multiple types of contraband detection systems are known, e.g., x-ray inspection systems and explosive trace detection systems.

X-ray inspection systems may inspect an item by detecting radiation transmitted and/or scattered from regions of the item. For example, U.S. Pat. No. 5,600,700 to Krug et al. entitled, “Detecting Explosives or other Contraband by Employing Transmitted and Scattered X-rays,” which is hereby incorporated by reference in its entirety, describes an x-ray inspection device for detecting a specific material of interest using transmitted and/or scattered x-rays. Some x-ray inspection systems determine physical properties of portions of an item under inspection, for example, density and/or atomic number, by detecting transmitted and/or scattered x-rays.

Some inspection systems may use more than one inspection modality to inspect an item (e.g., for multi-level screening). For example, U.S. Pat. No. 5,642,393 to Krug et al. entitled, “Detecting Contraband by Employing Interactive Multiprobe Tomography,” which is hereby incorporated by reference in its entirety, describes an inspection system that uses more than one inspection modality to inspect an item.

A novel inspection system employing terahertz radiation is described below. Terahertz radiation refers to electromagnetic radiation in the range generally between what may be considered microwave and infrared radiation. This range extends from approximately 0.1×10¹² Hz to approximately 3×10¹² Hz, and is generally not visible to a human. Methods for generating and detecting terahertz radiation are known. For example, U.S. Pat. No. 6,844,552 entitled, “Terahertz Transceivers and Methods for Emission and Detection of Terahertz Pulses Using Such Transceivers,” which is hereby incorporated by reference in its entirety, describes a system for emitting and detecting terahertz frequency electromagnetic pulses.

### SUMMARY OF INVENTION

In a first aspect, the invention relates to a method of inspecting an item that includes a plurality of regions. The method includes detecting terahertz radiation that has interacted with the plurality of regions. The method also includes determining a density of each of the plurality of regions.

In another aspect, the invention relates to a method of inspecting an item that includes a plurality of regions. The method includes detecting terahertz radiation reflected from the item. The method also includes determining a physical property of each of the plurality of regions.

In yet another aspect, the invention relates to an inspection system that includes an inspection region adapted to receive an item under inspection. The system includes a terahertz radiation source located adjacent to the inspection region. The system also includes a terahertz radiation detector located adjacent to the inspection region. The system further includes a controller/processor coupled to the terahertz radiation detector that receives detection information from the terahertz radiation detector and determines, at least partially based on the detection information, density information about the item under inspection.

In a further aspect, the invention is directed to a method of determining the presence of a threat object within an item under inspection. The method includes inspecting the item using a first inspection modality to produce first inspection information. The method also includes detecting terahertz radiation that has interacted with the item under inspection. The method also includes determining second inspection information at least partially based on the detected terahertz radiation. The method further includes determining third inspection information at least partially based on the first and second inspection information.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch an embodiment of a terahertz inspection system;

FIG. 2 is a block diagram of software and hardware components of a terahertz inspection system;

FIG. 3 is a sketch illustrating transmitted and detected terahertz pulse waveforms;

FIG. 4 is a sketch illustrating the reflectance of a particular explosive to terahertz radiation of various frequencies;

FIG. 5A is a sketch of a piece of baggage showing the location of a cross section of an item under inspection;

FIG. 5B is a density map of a cross section taken along the line B-B of the item under inspection of FIG. 5A;

FIG. 5C is a sketch of a threat object within a cross section taken along the line B-B of the item under inspection of FIG. 5A; and

FIG. 6 is a diagram illustrating a method of inspecting items using more than one inspection modality.

### DETAILED DESCRIPTION

In some aspects, the invention relates to inspection systems such as those used to inspect luggage or packages to determine the presence of contraband such as explosives, weapons or drugs. A more specific example is the inspection of luggage that is to be checked onto airline flights or carried on to an airplane. In one aspect the invention relates to the use of terahertz radiation for the detection of explosives or other contraband, such as may be concealed in luggage. Terahertz radiation is non-ionizing and biologically inert, therefore its implementation in a crowded environment may pose fewer health and safety concerns than other types of radiation, e.g., x-rays.

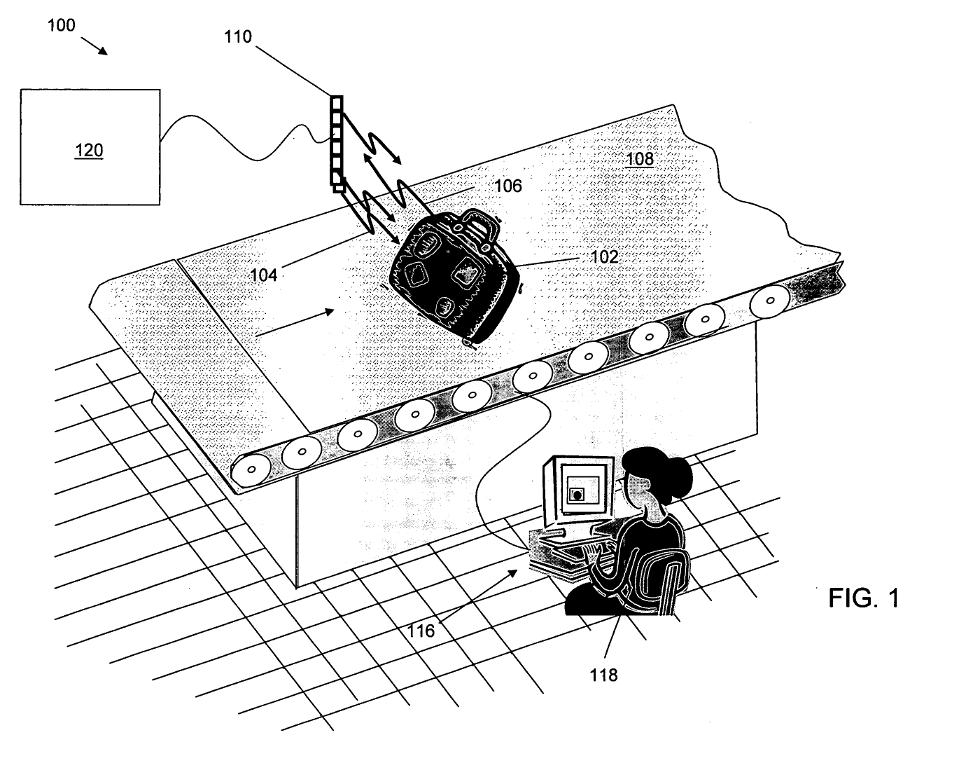

FIG. 1 illustrates an example of an inspection system 100, such as may be used for screening luggage, employing terahertz radiation. Inspection system 100 may emit terahertz radiation towards an item under inspection 102 and detect radiation that has interacted with the item under inspection 102. Inspection system 100 may analyze the detected radiation to determine physical properties and/or a screening result for item under inspection 102. For example, a screening result may indicate whether the item under inspection 102 contains a suspicious region or has been “cleared” (e.g., to be checked onto an airline flight or carried on to an airplane).

Inspection system 100 may be configured to provide relative motion between luggage or other items under inspection and a terahertz transmitter/detector array 110. For example, the inspection system 100 may include a conveyor 108, such as is used in a conventional x-ray imaging system, for moving an item under inspection 102 past a terahertz transmitter/detector array 110.

Terahertz transmitter/detector array 110 may include transmitters 114 for emitting transmitted terahertz radiation 104 towards an item under inspection 102, and detectors 112 for receiving terahertz radiation 106 that has interacted with a portion of the item. Transmitters 114 may emit a pulse of terahertz radiation that contains multiple frequency components across the terahertz frequency band.

As the item under inspection 102 moves down the conveyor, the item under inspection 102 may pass through the path of transmitted radiation 104 and different regions of the item under inspection 102 may fall in the path of the transmitted radiation 104. The transmitted radiation 104 may interact with various regions of item under inspection 102, and a portion of the radiation (e.g., reflected radiation 106) may be reflected from a portion of the item (e.g., an interface between two or more regions). Reflected radiation 106 may be reflected from the portion of the item towards detectors 112 which may detect the reflected radiation 106. In this way, different regions of item under inspection 102 may be scanned as item under inspection 102 moves past transmitter/detector array 110.

FIG. 1 shows a simple configuration of a fixed transmitter/detector array 110 emitting transmitted radiation 104 and also receiving reflected radiation 106. Detectors 112 may be located on the same side of the item as transmitters 114 or in any other suitable location. In some embodiments, transmitters 114 should preferably not be active while detectors 112 are measuring reflected radiation to avoid interference.

More complicated detector and transmitter array configurations may be employed. For example, a transmitter array may be positioned on one side of the item and a detector array may be positioned on another side of an item. Such a configuration may be used to detect terahertz radiation transmitted through the item. In another example, both transmitted and reflected radiation may be detected. To avoid interference, it may be preferable to position a detector measuring reflected radiation for a reflection measurement orthogonal to a transmitter providing radiation for a transmission measurement.

More than one array of transmitters and/or detectors may be used. For example, transmitter arrays may be positioned on two or more sides of an item under inspection. If a transmission measurement is to be made, opposing transmission and detector arrays may be positioned opposite each of the transmitter arrays. In one embodiment, an item under inspection may be fully surrounded by transmitter and detector arrays, allowing the item to be inspected from multiple angles. Alternatively, the transmitter and detector arrays may be mounted on a rotating gantry, e.g., in a similar configuration to CT x-ray scanners.

In some embodiments, detectors receiving reflected radiation may not be positioned close to the transmitters that emit the radiation. Detectors 112 may be placed in any suitable position to detect reflected radiation.

For example, in the embodiment illustrated in FIG. 1, transmitters 114 are shown as emitting terahertz radiation toward the item in a direction orthogonal to the direction of motion of the conveyor 108. However, the transmitters 114 may emit terahertz radiation towards an item in a direction that is not orthogonal to the direction of motion of the conveyor 108. Detectors 112 may be positioned at an appropriate angle to receive radiation reflected from the item in a direction that is not orthogonal to the direction of motion of the conveyor 108. For example, transmitters and detectors may be positioned in a configuration similar to “forward scatter” and/or “backscatter” x-ray imaging systems.

In some embodiments, terahertz radiation may be used to inspect a leading and/or trailing edge of item under inspection 102. A leading edge may be the first portion of item under inspection 102 to pass through inspection system 100. A trailing edge may be the last portion of item under inspection 102 to pass through inspection system 100. To inspect leading and/or trailing edges of item under inspection 102, transmitters 114 and detectors 112 may be positioned in any suitable configuration, for example, on one or more sides of conveyor 108, above conveyor 108 and/or below conveyor 108.

Once reflected radiation 106 is detected by detectors 112, signals may be created that are sent to controller/processor 120 (or any other suitable hardware and/or software system) where the signals can be processed to extract information about objects within an item under inspection. Information (e.g., related to distance, position, density, index of refraction and/or another physical property) collected on successive segments of the bag can be assembled to form an image of all or a portion of the item under inspection that can be presented graphically to a human operator 118. Such information may be analyzed by a computer 116, controller/processor 120 and/or any other suitable hardware, software or combination thereof.

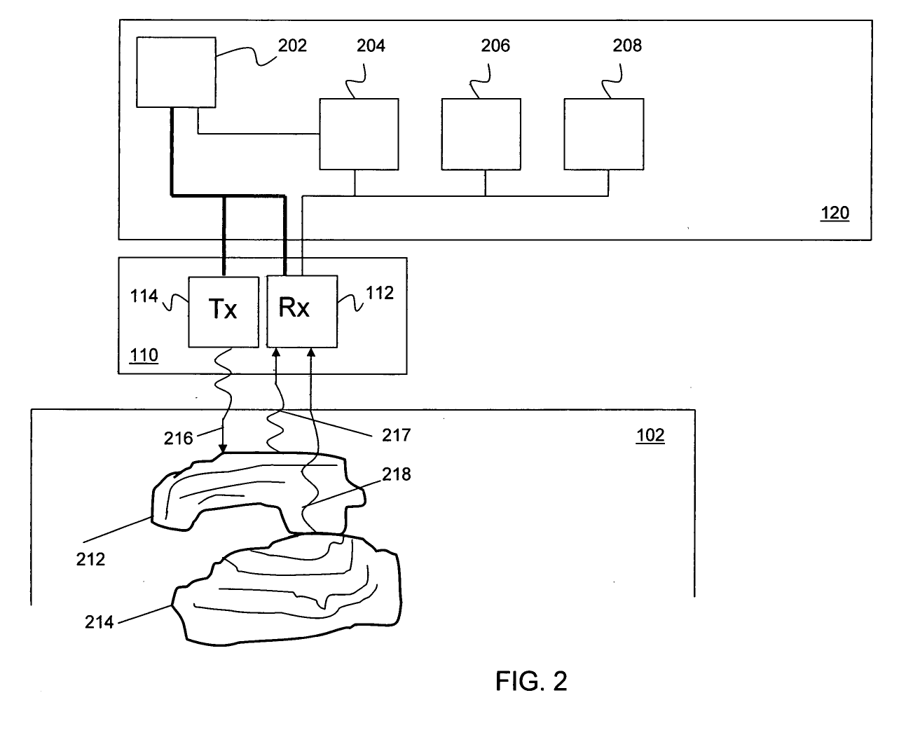

FIG. 2 illustrates an example of a portion of inspection system 100 in greater detail. In particular, FIG. 2 illustrates an example of a controller/processor 120 that may control the transmission of terahertz radiation, control the detection of terahertz radiation and/or analyze the detected terahertz radiation. Controller/processor 120 may include a pulse generator 202, a timing module 204, a magnitude/phase module 206 and a spectrum module 208.

Pulse generator 202 may control the generation of a terahertz radiation pulse by transmitters 114. For example, pulse generator 202 may generate an optical pulse that may be used to gate transmitters 114. Once transmitters 114 receive the optical gating pulse, transmitters 114 may emit a transmitted terahertz pulse 216 towards an item under inspection 102. Pulse generator 202 may generate and/or control the generation of a terahertz radiation pulse in any suitable way, including techniques that are known in the art.

Transmitted terahertz pulse 116 may interact with one or more portions of an item under inspection 102. For example, a portion of transmitted terahertz pulse 104 may be reflected by region 212, e.g., reflected terahertz pulse 217. Another portion of transmitted terahertz pulse 216 may propagate through region 112 until it reaches an interface between regions 212 and 214. A reflected terahertz pulse 218 may be reflected from this interface. Other portions of transmitted terahertz pulse 116 may be reflected by other portions, interfaces and regions of item under inspection 102. In this example, only two reflected terahertz pulses are illustrated for the sake of clarity.

One or more of reflected terahertz pulses 217 and 218 and/or other reflected terahertz pulses may be detected by detectors 112. Various aspects of a reflected terahertz pulse may be determined, for example, the time at which the pulse is detected, the magnitude of the pulse and the frequency spectrum of the pulse. Transmitter/detector array 110 may transmit a signal that represents the pulse and/or various aspects of the pulse to controller/processor 120.

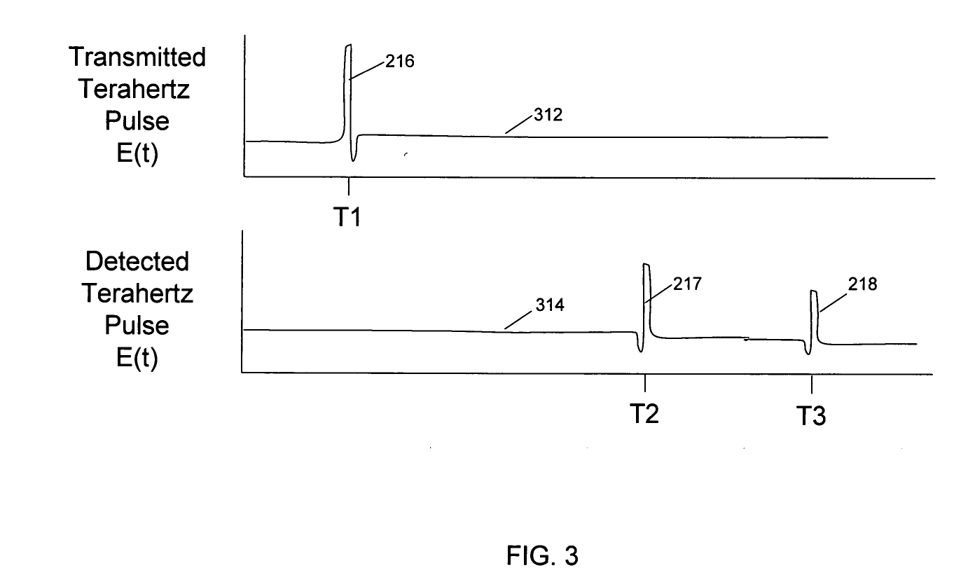

Once controller/processor 120 receives the signal it may analyze the signal in various ways to determine various aspects of the item under inspection. For example, controller/processor 120 may determine one or more physical properties (e.g., density or index of refraction) of regions 212 and/or 214, the location of regions 212 and/or 214 or additional information. In one aspect of the invention, controller/processor 120 may generate a volume reconstruction of a portion or all of item under inspection 102 as discussed below. FIG. 3 is a sketch illustrating examples of terahertz pulse electric field waveforms 312 and 314. As discussed above, transmitter 114 may emit transmitted terahertz pulse 216 at time T1, as represented by waveform 312. Timing module 204 may store a representation of the time T1 at which transmitted terahertz pulse 216 was emitted. Timing module 204 may be a hardware circuit, software module or combination thereof, configured to store a representation of the times at which terahertz pulses are emitted and detected.

As discussed above, a portion of transmitted terahertz pulse 216 (e.g., reflected terahertz pulse 217) may be reflected from a portion of item under inspection 102 (e.g., region 212). The position of the portion of item under inspection 102 from which a pulse is reflected may be determined by the time of arrival of the reflected pulse at a detector array, as well as the position of the detector array. Waveform 314 illustrates the detection of reflected terahertz pulse 217 at time T2. Another portion of transmitted terahertz pulse 216 (e.g., reflected terahertz pulse 218) may be reflected from another portion of item under inspection 102 (e.g., an interface between regions 212 and 214. Waveform 314 illustrates the detection of reflected terahertz pulse 218 at time T3.

The difference in time between the emission of transmitted terahertz pulse 216 and the detection of reflected terahertz pulse 217 (T2−T1) may provide information about the distance between transmitter/detector array 110 and the portion of item under inspection 102 from which radiation was reflected. For example, the distance between transmitter/detector array 110 and region 212 may be C(T2−T1)/2, where C is the speed of light in a medium through which the terahertz pulse has passed. Similarly, the distance between transmitter/detector array 110 and the interface between regions 212 and 214 may be C(T3−T1)/2. Controller/processor 120 and/or one or more processes running on controller/processor 120 may perform this calculation.

Magnitude/phase module 206 may be a hardware circuit, software module or combination thereof, configured to determine the magnitude and/or phase of the electric field of a detected terahertz pulse. The magnitude of a pulse may indicate the amount of radiation reflected from a region within the item under inspection 102. The amount of radiation reflected may depend on a change in index of refraction, density and/or another physical property between two regions. Additionally, the amount of reflected radiation may be indicative of the density of regions through which a terahertz pulse has passed, the distance the radiation has traveled and/or other factors related to physical properties of the regions. Magnitude/phase module 206 may be configured to determine the magnitude of terahertz pulses detected at various times and process this magnitude information to generate a volume reconstruction of a portion or all of an item under inspection 102 as discussed above.

A volume reconstruction may be generated in any suitable way. For example, the positions of interfaces between regions of item under inspection 102 may be determined based on time of transit of the terahertz radiation. The density (or another physical property) of the regions may be determined as a function of the attenuation of the reflected terahertz radiation, the relative phase of the reflected terahertz radiation and/or the polarity of a received terahertz pulse. In one embodiment, a volume reconstruction may be determined iteratively. For example, a reconstruction may first be performed for regions of item under inspection 102 closest to a detector array. Using information determined for these reconstructed regions (e.g., index of refraction information, density information and transmission coefficients), a reconstruction may be performed for regions further away from the detector array. Any suitable algorithm may be used.

Some explosives and biological agents may have unique signatures in the terahertz range of the electromagnetic spectrum. For example, a particular explosive (e.g., Semtex, RDX or TNT) may have a particular reflectance characteristic across the terahertz frequency range. Exposing an item to a terahertz pulse that may contain multiple terahertz frequency components and examining the magnitude and/or phase of terahertz frequency components of a terahertz pulse reflected from the item may facilitate the detection of explosives and/or biological agents.

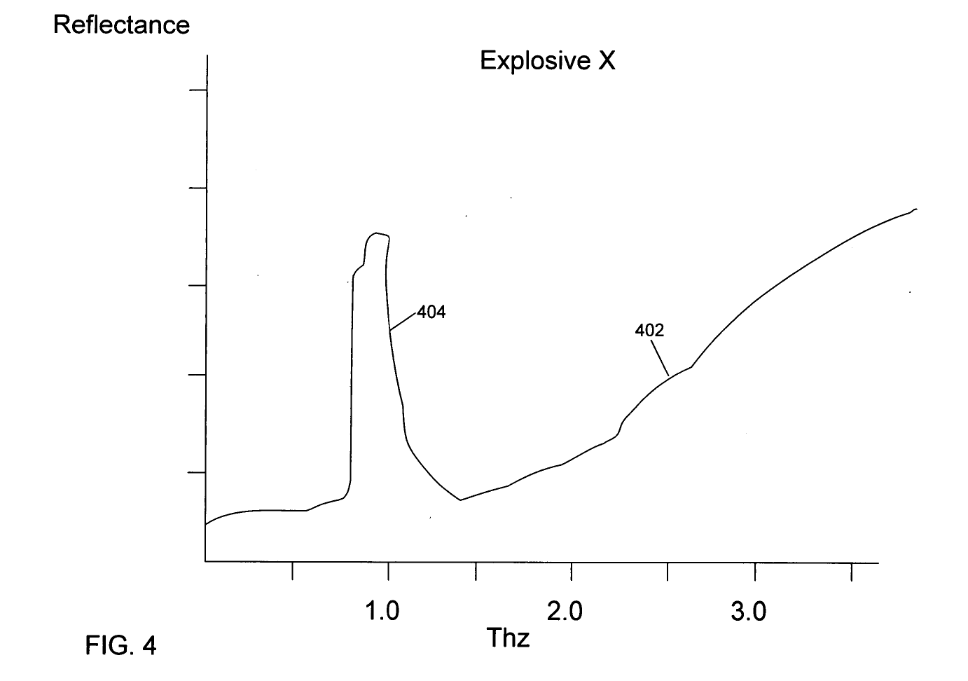

FIG. 4 is a sketch illustrating an example of a reflectance characteristic of a hypothetical explosive material “Explosive X.” FIG. 4 includes a trace 402 representing the reflectance of Explosive X over a variety of frequencies in the terahertz range. Trace 402 may have a peak 404, for example, at a particular frequency range of the terahertz spectrum. Peak 404 may indicate that Explosive X reflects a significant amount of radiation at a particular frequency (e.g., 1.0 THz).

Spectrum module 208 may be a hardware circuit, software module or combination thereof configured to determine a reflectance characteristic of one or more portions of item under inspection 102. Spectrum module 208 may determine the magnitude and/or phase of various terahertz frequency components of a transmitted and/or reflected terahertz pulse. For example, spectrum module 208 may be configured to detect Explosive X by determining whether a terahertz pulse reflected from an item contains a frequency component of significant magnitude at 1.0 THz, in comparison to frequency components at 0.5 or 1.5 THz, for example.

The presence of a spectral peak is one example of a criteria that may be used for determining whether an explosive material is present based on the reflectance spectrum. A variety of other criteria may be used, for example, frequency component magnitudes at various frequencies, phases of various frequency components and/or any other suitable criteria unique to particular explosives and/or biological materials. The analysis of the spectrum may be performed by spectrum module 208, controller/processor 120 and/or any other suitable system.

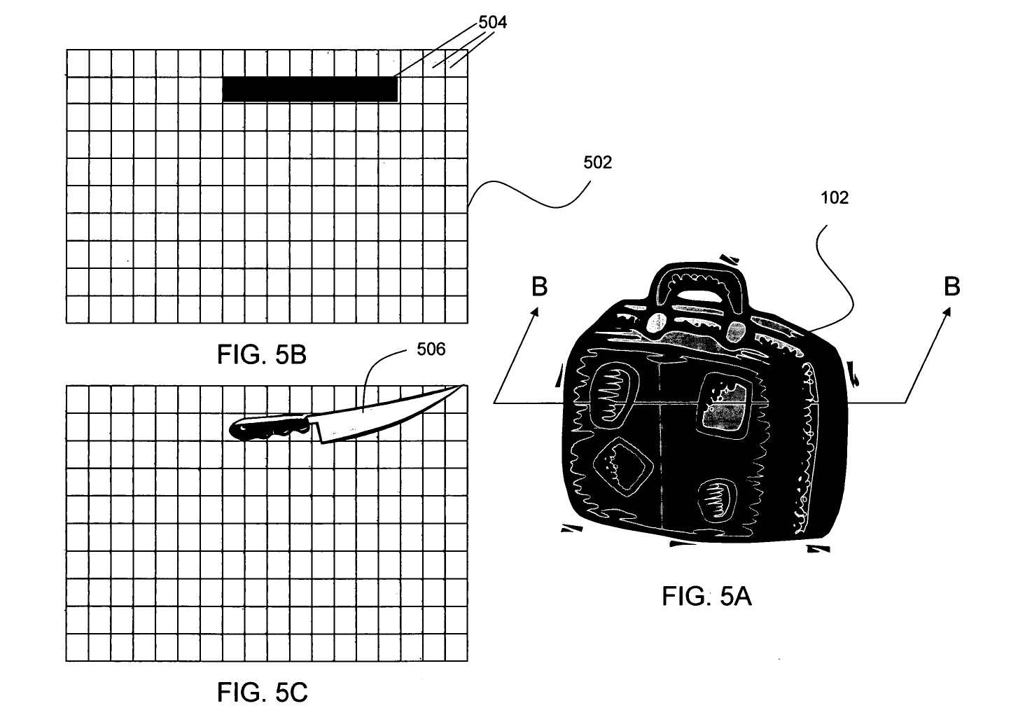

FIG. 5A is a sketch of item under inspection 102. A cross-section of item under inspection 102 is indicated by the cross-section indicated by the line B-B. As discussed above, a volume reconstruction of item under inspection 102 may be produced.

A volume reconstruction may include information about a physical property (e.g., density or index of refraction) of multiple regions within item under inspection 102. A portion of all of such a volume reconstruction may be represented to a human operator 118, e.g., on a baggage viewing station such as computer 116. In some aspects of the invention, a volume reconstruction may be further processed by controller/processor 120, computer 116 and/or another system to determine further information. For example, a volume reconstruction may include a density map.

FIG. 5B illustrates a density map 502 that may be determined for the cross-section B-B of item under inspection 102.

Density map 502 may be a set of voxels 504 that represent multiple regions within item under inspection 102. Each voxel 504 may have associated with it density information (e.g., a density value) determined for the region represented by the voxel 504. A collection of voxels may represent an object. In some aspects of the invention, voxels may be visually represented to human operator 118, e.g., on a baggage viewing station such as computer 116. Density may be represented to human operator 118 as one or more tones, e.g., colors or shades or gray. For example, a dark tone may represent a region of high density and a light tone may represent a region of low density. By viewing density map 502, human operator 118 may determine the presence of a suspicious object within item under inspection 102.

One or more algorithms may be used to determine the presence of a suspicious object using density map 502. Once information about an item under inspection—such as density map 502 and/or another physical property—is obtained, this information may be processed analogously to the processing used in x-ray inspection systems. For example, U.S. Pat. No. 6,816,571 of Bijjani et al. entitled “Method and Apparatus for Transmitting Information About a Target Object Between a Prescanner and a CT Scanner,” which is hereby incorporated by reference in its entirety, describes that information about density and material characteristics may used iteratively to refine a representation of objects within an item under inspection. Likewise, U.S. Pat. No. 5,345,514 of Mahdavieh et al., entitled “Method for Inspecting Components Having Complex Geometric Shapes,” which is hereby incorporated by reference in its entirety, describes further processing techniques that may be used in connection with density and/or physical property information (e.g., density map 502 and/or a volume reconstruction) for the purpose of detecting contraband or explosives. Density information, a volume reconstruction and/or other physical property information obtained using terahertz radiation may be processed in a similar fashion. Such processing may be done by controller/processor 120 and/or any other suitable system.

FIG. 5C illustrates an example of a threat object 506 that may be detected by inspection system 100. Threat object 506 may be detected because voxels 504 representing the regions of item under inspection 102 containing threat object 506 may have density information that is different from the density of surrounding regions. As illustrated in FIG. 5B, the density map 504 includes several voxels 504 which have darker tones, which in this example indicate a higher density than in the surrounding regions.

Inspection system 100 may be used as part of a multi-level screening system (e.g., at an airport) for inspecting items to detect the presence of contraband. A multi-level screening system may employ more than one inspection modality.

As used herein, the term “inspection modality” means a mode of inspecting at least a portion of an item. Examples of inspection modalities include x-ray inspection, inspection, using terahertz radiation, explosives trace analysis, proton emission tomography (PET) and nuclear quadrupole resonance (NQR).

A multi-level screening system may, for example, employ two levels of inspection. Level one inspection may include x-ray inspection, and level two inspection may include inspection using terahertz radiation (e.g., using inspection system 100). Inspection system 100 may be used for examining the surface regions of items under inspection.

X-ray inspection may provide information about objects positioned on the interior of items under inspection (i.e. because of the penetrating ability of x-rays). However, x-ray inspection may have difficulty detecting some types of threat objects that may be positioned near the surface of an item under inspection, such as sheet explosives. A sheet explosive may not significantly attenuate x-rays transmitted through the sheet object. Information determined using x-ray inspection may be used to determine a screening result and/or the presence of a threat object.

Inspection using terahertz radiation may provide information about the surface regions of regions of items under inspection. Terahertz radiation may be particularly useful for detecting sheet explosives and/or other contraband positioned near the surface of an item under inspection. Information determined from inspection using terahertz radiation may be used to determine a screening result and/or the presence of a threat object (e.g., sheet explosive) using any of the techniques described above. Information determined from inspection using terahertz radiation may be combined with information determined from inspection using x-rays to determine further information, such as a screening result and/or the presence of a threat object.

A screening result determined for an item under inspection may indicate the status of the inspection of the item. For example, if an inspection system is capable of resolving a threat, it may provide a screening result indicating that a confirmed threat object is present. The item under inspection may then be handled appropriately based on the type of confirmed threat. As another example, an inspection system may not be capable of resolving a threat, but may provide a screening result indicating that one or more suspicious regions are present. In this case, the item may be further inspected (e.g., using another level of inspection). As a further example, if an inspection system is capable of making such a determination, it may indicate that an item has been “cleared” and that no threat objects are present.

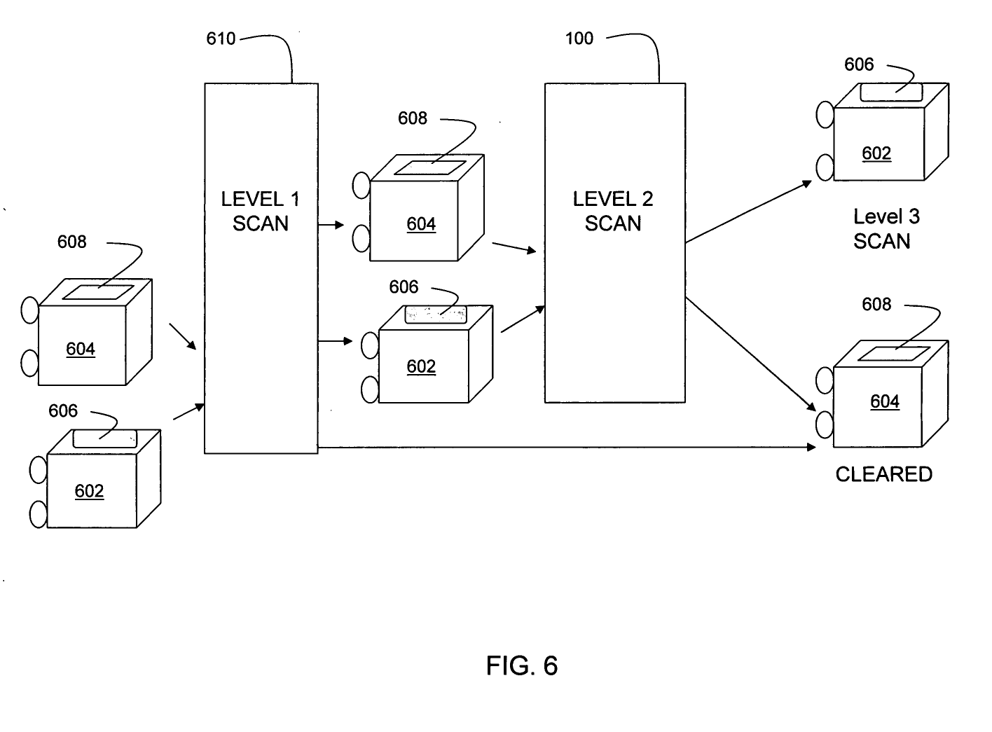

FIG. 6 is a diagram illustrating the use of terahertz imaging in connection with an overall security system, such as an may be employed at an airport. Items under inspection, such as a suitcases 606 and 608, may be passed to a level one system 610 for level one scanning.

A level one system 610 may be, for example, an x-ray line scanner. The level one system 610 may employ dual energy x-rays in order to identify materials having effective atomic numbers characteristic of explosives or other items of contraband. A level one system 610 may be capable of providing sufficient information about an item such that a human operator or computerized threat detection algorithm can determine whether suspicious objects are contained within the item under inspection. If level one system 610 determines that no suspicious objects are present, the item under inspection may be “cleared” for boarding on an aircraft or otherwise passed through the inspection station.

However, when the level one scanner cannot determine with sufficient confidence that no threat items are contained within the item under inspection, the item may be passed to a level two system (e.g., inspection system 100) employing terahertz radiation for further inspection. For example, the level one system 610 may determine that suitcases 602 and 604 contain suspicious objects. Suitcase 602 may contain a sheet explosive 606 hidden on one side of suitcase 602. Suitcase 604 may contain a harmless suitcase frame 608. Level one system 610 may be capable of determining that suitcases 602 and 604 contain suspicious regions, however, it may not be capable of determining whether a suspicious region is a threat object.

In some circumstances, it may be difficult for a level one system to inspect regions at or near the surface of an item under inspection. An item under inspection (e.g., a suitcase) may have various supporting members, such as suitcase frame 608, that may obscure the presence of threat objects. It may be difficult for a level one system to tell whether an item under inspection 102 contains a suitcase frame 608, a sheet explosive 606, or both. Both suitcases 602 and 604 may be sent to a level two system (e.g., inspection system 100) that uses terahertz radiation to further inspect suitcases 602 and 604. A level two system (e.g., inspection system 100) may, for example, be used to inspect the surface regions of suitcases 602 and 604.

The level two system may confirm that an object identified as “suspicious” or by the level one system 610 is not, in fact, a threat object. For example, inspection system 100 may determine that suitcase frame 608 is not a threat object. In this case, suitcase 604 may be cleared by the level two system. Items not cleared by the level two system may be further inspected—possibly manually—or may be rejected or otherwise handled as confirmed threats. For example, inspection system 100 may determine sheet explosive 606 to be a threat object based on one or more of the techniques discussed above. In this case, suitcase 602 may be further inspected or otherwise handled.

It should be appreciated that an inspection system 100 using terahertz radiation may be alternatively used as the level one system. Additionally, in one embodiment, terahertz radiation may be used in more than one level of scanning. For example, information determined from radiation transmitted through an item may provide level one inspection information. Where suspicious objects are detected, information gathered from reflected radiation may provide level two inspection information.

In one embodiment, information determined about an item under inspection using inspection system 100 may be used in combination with information determined using another inspection modality. For example, a screening result may be determined based on information determined by inspection system 100 and information determined by an x-ray inspection system. A combination of information from two different sources may provide level one inspection information. For example, all items under inspection may be required to undergo both x-ray inspection and inspection using terahertz radiation

In some embodiments, inspection system 100 may be located close to an inspection system that uses a different inspection modality. For example, the two systems may be housed in the same unit. Such a configuration may be used when a combination of information from inspection system 100 and information from x-ray inspection (or another inspection modality) is used to determine a screening result. Alternatively, the two inspection systems may be housed in different units, for example, for multi-level inspection. When terahertz imaging techniques, such as those described above, are used for multi-level screening, many types of scanners may be used for other scanning levels. Line scanners or dual energy line scanners may be used. Alternatively, CT or dual energy CT scanners may be used. For example, a screening result may be determined for the item under inspection based on information determined from inspection using inspection system 100 and information determined for the item under inspection using another inspection modality (e.g., CT x-ray inspection).

An inspection system that uses terahertz radiation may be used as a stand-alone system for detecting contraband in items under inspection (e.g., carry-on items and checked baggage). In some embodiments, such an inspection system may examine items such as shoes and laptop computers. A inspection system that uses terahertz radiation may be an alternative to x-ray inspection for items that may be sensitive to x-rays.

In some embodiments, an inspection system that uses terahertz radiation may be used for personnel screening (e.g., to detect the presence of contraband). If terahertz radiation is used for personnel screening, the “item under inspection” may include a human being. Terahertz radiation may be biologically inert, non-ionizing and/or non-invasive, and may be used in addition to or as an alternative to known personnel screening techniques (e.g., metal detectors and hand searches). For example, metal detectors cannot detect explosives or drugs, and may have difficulty examining some passengers (e.g., passengers in wheelchairs). As another example, some passengers may be comfortable with hand searches. Terahertz radiation may provide a viable substitute and/or supplement to such personnel screening techniques. A system for screening personnel is described in co-pending U.S. application Ser. No. 10/962,693 entitled “MMW Contraband Screening System,” which is hereby incorporated by reference in its entirety. A personnel screening system that uses terahertz radiation may be similar to such a system, however, it may use terahertz radiation instead of, or in addition to, millimeter waves.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be-part of this disclosure, and are intended to be within the spirit and scope of the invention. Accordingly, the foregoing description and drawings are by way of example only.

What is claimed is:

1. A method of inspecting an item comprising a plurality of regions, the method comprising acts of:
A) detecting terahertz radiation that has interacted with the plurality of regions;
B) determining a density of each of the plurality of regions at least partially based on the act A; and
C) determining, at least partially based on the density, the presence of a contraband object at least partially within the plurality of regions:

2. The method of claim 1, wherein the plurality of regions are surface regions of the item.

3. The method of claim 1, wherein the terahertz radiation has been reflected by the item prior to the act A.

4. The method of claim 3, wherein the terahertz radiation has been reflected by an interface between at least two of the plurality of regions prior to the act A.

5. The method of claim 1, wherein the act B comprises determining the density at least partially based on a magnitude and/or phase of the terahertz radiation detected in the act A.

6. The method of claim 1, wherein the act B comprises determining the density at least partially based on the time at which the terahertz radiation was detected in the act A.

7. The method of claim 1, further comprising an act of:
D) determining, at least partially based on the density, a multi-dimensional representation of an object located at least partially within the plurality of regions.

8. The method of claim 1, wherein the contraband object is an explosive.

9. The method of claim 1, wherein the item comprises a human.

10. A method of inspecting an item comprising a plurality of regions, the method comprising acts of:
A) detecting terahertz radiation reflected from the item;
B) determining a physical property of each of the plurality of regions at least partially based on the act A; and
C) determining, at least partially based on the physical property, whether a contraband object is within the item.

11. The method of claim 10, further comprising an act of:
D) determining, at least partially based on the physical property, a multi-dimensional representation of an object located at least partially within the plurality of regions.

12. The method of claim 10, wherein the plurality of regions are surface regions of the item.

13. The method of claim 10, wherein the physical property determined in the act B is an index of refraction.

14. The method of claim 10, wherein the terahertz radiation has been reflected by the item prior to the act A.

15. The method of claim 10, wherein the act B comprises determining the physical property at least partially based on a magnitude and/or phase of the terahertz radiation detected in the act A.

16. The method of claim 10, wherein the act B comprises determining the physical property at least partially based on the time at which the terahertz radiation was detected in the act A.

17. The method of claim 10, further comprising an act of:
D) determining a screening result for the item at least partially based on the multi-dimensional representation.

18. The method of claim 11, further comprising an act of:
D) determining a reflectance of at least one of the plurality of regions to terahertz radiation of a plurality of frequencies.

19. The method of claim 10, wherein the contraband object is a sheet explosive.

20. An inspection system comprising an inspection region adapted to inspect an item comprising a plurality of regions, the system comprising:
a terahertz radiation source located adjacent to the inspection region;
a terahertz radiation detector located adjacent to the inspection region; and
a controller/processor coupled to the terahertz radiation detector that receives detection information from the terahertz radiation detector, determines density information at least partially based on the detection information and determines, at least partially based on the density information, whether a contraband object is within the item.

21. The inspection system of claim 20, further comprising a timing module to store an arrival time of the terahertz radiation at the terahertz radiation detector.

22. The inspection system of claim 20, further comprising a magnitude/phase module to determine a magnitude and/or phase of an electric field of the terahertz radiation detected by the terahertz radiation detector.

23. The inspection system of claim 20, further comprising a spectrum module to measure an intensity and/or phase of the terahertz radiation for a plurality of frequencies, the terahertz radiation being detected by the terahertz radiation detector.

24. A method of inspecting an item to detect the presence of a contraband object, the method comprising acts of:
A) inspecting the item using a first inspection modality to produce first inspection information;
B) detecting terahertz radiation that has interacted with the item;
C) determining, at least partially based on the terahertz radiation detected in the act B, second inspection information; and
D) determining, at least partially based on the first and second inspection information, third inspection information.

25. The method of claim 24, wherein the second inspection information comprises density information about surface regions of the item.

26. The method of claim 24, further comprising an act of:
E) determining a reflectance of at least a portion of the item to terahertz radiation of a plurality of frequencies.

27. The method of claim 24, wherein the terahertz radiation is detected in the act B in response to a detection of a suspicious region within the item by the first inspection modality.

28. The method of claim 24, wherein the first inspection information comprises an indication of a suspicions region within the item.

29. The method of claim 24, wherein the third inspection information comprises an indication that the item is cleared.

30. The method of claim 24, wherein the third inspection information comprises an indication that further inspection of the item is required.

31. The method of claim 24, wherein the first inspection modality is x-ray inspection.
